(19) United States
(12) Patent Application Publication
(10) Pub. No.: US 2009/0013842 A1
(43) Pub. Date: Jan. 15, 2009

(54) Power Tool

(75) Inventors: Heiko Rosskamp, Adelberg (DE); Jorg Elfner, Waiblingen (DE); Roland Schierling, Affalterbach (DE); Peter Bauer, Winnenden (DE)

Correspondence Address: GUDRUN E. HUCKETT DRAUDT, SCHUBERTSTR. 15A, WUPPERTAL, 42289, DE

(73) Assignee: ANDREAS STIHL AG & CO. KG, Waiblingen (DE)

(21) Appl. No.: 12/165,818

(22) Filed: Jul. 1, 2008

(30) Foreign Application Priority Data
Jul. 10, 2007 (DE) 102007032043.6

(51) Int. Cl. B26D 7/00; B23Q 5/00; B25D 17/10

(52) U.S. Cl. 83/523; 173/213; 173/162.1

(57) ABSTRACT

A power tool has a drive motor that drives a tool and an optical guiding device secured on the power tool in alignment relative to the work tool. The guiding device is arranged in a low-vibration arrangement on the power tool and is in particular secured on the power tool in a low-vibration area of the power tool. At least one section of the power tool vibrates in the form of a standing wave in at least one direction, wherein the low-vibration area where the guiding device is arranged is the area of a node of the standing wave.

### BACKGROUND OF THE INVENTION

The invention concerns a power tool comprising a drive motor that drives a work tool and comprising an optical guiding device that is secured on the power tool in alignment relative to the work tool.

DE 10 2004 002 747 A1 discloses a motor chainsaw that comprises a laser for measuring partial lengths of a workpiece wherein the laser generates a laser dot as a visual aid on the workpiece. The laser is fixedly connected to the housing by a holder.

In electric power tools such as electric hand-held circular saws or electric jigsaws, lasers are known as a guide for the cutting direction. The lasers are fixedly mounted on the housing of the power tool.

In operation of such a motor-driven power tool vibrations are generated. On the one hand, these vibrations cause mechanical stress on the laser and, on the other hand, they cause imprecise guiding.

The invention has the object to provide a power tool of the aforementioned kind whose guiding device has a long service life and provides a satisfactorily precise guiding.

### SUMMARY OF THE INVENTION

This object is solved by a power tool of the aforementioned kind wherein the guiding device is arranged in a low-vibration arrangement on the power tool.

The low-vibration arrangement of the guiding device on the power tool has the result that only minimal vibrations are transmitted onto the guiding device. In this way, the mechanical stress on the guiding device is reduced, on the one hand, and impairment of guiding as a result of vibrations is reduced, on the other hand. In a simple way, a guiding action of excellent quality can be achieved.

Advantageously, the guiding device is secured on the power tool in a low-vibration area of the power tool. With the targeted selection of the area in which the guiding device is secured on the power tool, the vibrations transmitted onto the guiding device can be minimized. Usually, in operation of the power tool at least one section of the power tool vibrates in at least one direction in the form of a standing wave. A low-vibration arrangement of the guiding device on the power tool can be achieved in a simple way in that the guiding device is arranged in the area of a node of the standing wave. In the area of the node of the standing wave the amplitude is zero. In the adjoining areas, the resulting amplitudes are also very low so that an arrangement of the guiding device at the node, or closely adjacent to the node, is expedient in order to achieve a minimal vibration load of the guiding device. By a suitable selection of the arrangement of the guiding device, a minimal transmission of vibrations onto the guiding device can be achieved in a simple way.

In order to achieve a low-vibration arrangement of the guiding device on the power tool, it can be provided alternatively or additionally that the guiding device is secured by means of at least one vibration damping element on the power tool. The vibration damping element can be, for example, a rubber buffer for a damping element of foamed plastic material. Other known vibration damping elements can also be advantageous.

In order to ensure that the guiding device in operation is not excited to perform resonant vibrations, it is provided that eigenfrequency of the guiding device is outside of the working engine speed range of the power tool. The eigenfrequency of the guiding device is selected in particular such that the eigenfrequency is a frequency where the amplitude of the vibration of the power tool has a local minimum. In this connection, the amplitude of the vibration of the power tool is decisive within an area in which the guiding device is secured. Advantageously, the amplitude of the vibration of the power tool at eigenfrequency of the guiding device has a global minimum. In this way, it is ensured that the guiding device is excited only at very small amplitudes at its eigenfrequency. In this way, large amplitudes of the guiding device can be avoided.

It is provided that the guiding device generates a line-shaped guide mark. In particular, the guiding device is arranged so as to be rotatable about an axis of rotation on the power tool. In this way, the guiding device can indicate the cutting direction of the work tool as well as an angular alignment of the work tool, for example, in order to perform perpendicular cuts. For this purpose, the guide mark can be aligned, for example, relative to an edge of the workpiece. Advantageously, the work tool is rotatable about an axis of rotation wherein the axis of rotation of the guiding device extends perpendicularly to the axis of rotation of the work tool. In order to adjust the position of the guide mark on the workpiece, it is provided that the guiding device is pivotably arranged on the power tool. The guiding device in this connection is in particular pivotable about a pivot axis that is parallel to the axis of rotation of the rotatingly driven work tool.

It is provided that the power tool has an energy supply device that supplies the guiding device with electric energy. In particular, the energy supply device is a generator. It is provided that the drive motor is an internal combustion engine. In particular in power tools that are driven by an internal combustion engine the vibrations that occur in operation are comparatively great. In this context, a low-vibration arrangement of the guiding device is expedient in order to project sufficiently good and precise guide marks on a workpiece. The internal combustion engine drives advantageously a crankshaft in rotation wherein the generator is arranged on the crankshaft of the drive motor. In that the guiding device is supplied with energy by a generator that is driven by the internal combustion engine, no additional energy supply is required. However, it can also be provided that the energy supply device is a battery.

Advantageously, the power tool is a cut-off machine with a rotatingly driven cutting wheel. In connection with a cut-off machine, the guiding device can indicate different cuts depending on the type of work being performed. A guiding device is advantageous in particular when manually guiding the cut-off machine. The guiding device is advantageous also when panels or the like are to be cut where angled cuts are required. The cutting wheel is at least partially covered by a protective cover. The guiding device is in particular arranged on the protective cover of the cutting wheel. The arrangement of the guiding device on the protective cover enables projection of an excellent simple guide mark for the cut to be performed by the cutting wheel. However, great vibrations occur on the protective cover in operation so that particularly when arranging a guiding device on the protective cover of a cut-off machine a low-vibration arrangement of the guiding device on the protective cover is advantageous. In particular, the guiding device is arranged in the plane of the cutting wheel on the protective cover. Minimal vibrations on the guiding device will result when the guiding device is arranged on the circumference of the protective cover in a central area of the circumference of the protective cover. A central area of the protective cover in this connection is an area that extends approximately across one third of the circumferential length of the protective cover. This area can include the node of the resulting vibration. As a result of the sine shape of the vibration the amplitude can be sufficiently small across one third of the circumferential length of the protective cover.

The drive motor is advantageously an internal combustion engine.

### BRIEF DESCRIPTION OF THE DRAWINGS

FIG. 1 is a side view of a cut-off machine.

FIG. 2 is a schematic section illustration of the cut-off machine of FIG. 1.

FIG. 3 is a schematic plan view onto the cut-off machine of FIG. 1.

FIG. 4 is a schematic side view of a cut-off machine.

FIG. 5 is a schematic illustration of an embodiment variant of the attachment of the guiding device on the protective cover of the cut-off machine.

FIG. 6 is a diagram that shows an exemplary course of the amplitude of the protective cover relative to the frequency.

FIG. 7 is another diagram that shows a different exemplary course of the amplitude of the protective cover relative to the frequency.

FIG. 8 is a schematic plan view onto a cut-off machine with the guiding device in a first rotational position.

FIG. 9 is a schematic plan view onto the cut-off machine of FIG. 8 with the guiding device rotated about 90°.

### DESCRIPTION OF PREFERRED EMBODIMENTS

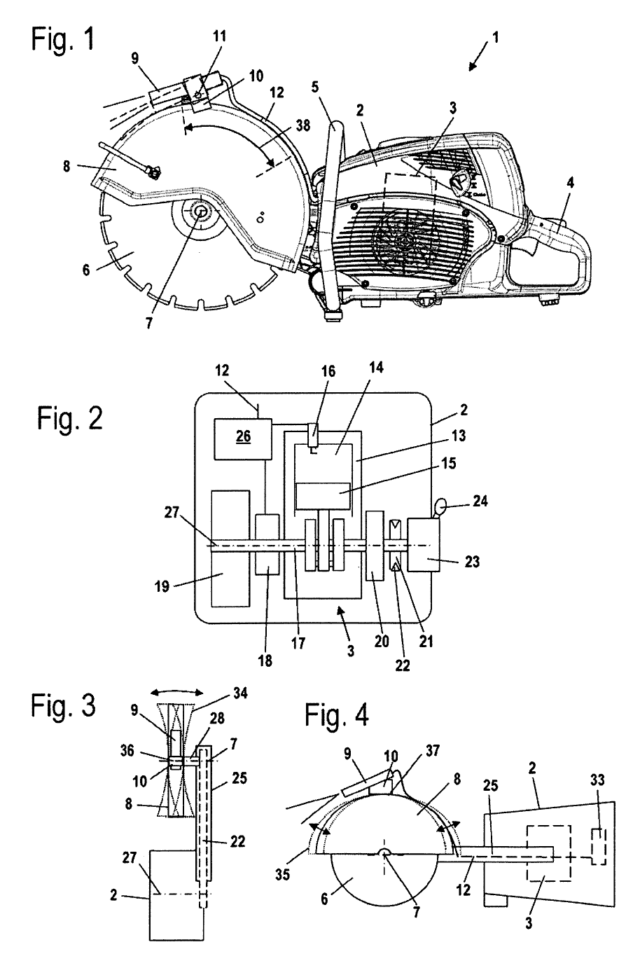

In FIG. 1 a power tool in the form of a cut-off machine 1 is shown. The cut-off machine 1 has a housing 2 in which a drive motor 3 is arranged. The drive motor 3 is embodied as an internal combustion engine. On the housing 2 handles, i.e., a rear handle 4 and a grip pipe 5, are secured. The rear handle 4 and the grip pipe 5 are connected to the drive motor 3 by means of vibration damping elements, not shown. The vibration damping elements can be secured between the handles and the housing 2, between the housing 2 and the drive motor 3, or between a part of the housing 2 where the handles are secured and a further part of the housing 2 where the drive motor is secured.

The cut-off machine 1 has a cutting wheel 6 as a work tool that is rotatingly driven by the drive motor 3 about axis of rotation 7. The cutting wheel 6 is partially covered by a protective cover 8. The protective cover 8 extends about half of the circumference of cutting wheel 6 and covers also the lateral faces of the cutting wheel 6 in this area.

The cut-off machine 1 can be mounted on a guide carriage but the cut-off machine 1 can also be freely guided by hand. In order to indicate to the operator where the cutting wheel 6 engages a workpiece, for example, the ground or panels to be cut, a guiding device 9 is secured on the protective cover 8. The guiding device 9 comprises a laser that generates a guide mark 32, schematically indicated in FIG. 8, on the workpiece.

The guiding device 9 is secured by a holder 10 on the protective cover 8. The holder 10 is of a two-part configuration wherein one part of the holder 10 is secured on the protective cover 8 and a second part of the holder 10 secures the guiding device 9. The two parts of the holder 10 are pivotable relative to one another about a pivot axis 11. The pivot axis 11 is positioned parallel to the axis of rotation 7 of the cutting wheel 6. In FIG. 1 a first position of the guiding device 9 is shown in solid lines and a second position of the guiding device 9 is shown in dashed lines. By pivoting the guiding device 9 about the pivot axis 11 the position of the guide mark can be adjusted.

The guiding device 9 is arranged in an area 38 of the protective cover 8 in which the amplitudes of the vibrations produced in operation are minimal. This area 38 extends in the shown embodiment across an angle of approximately 60° about the circumference of the protective cover 8. The guiding device 9 is arranged on the circumference of the protective cover 8 such that the guide mark 32 in the alignment of the guiding device 9 illustrated in FIG. 8 is within the same plane as the cutting wheel 6. The area 38 is located at the circumference of the protective cover 8 in a central area. The angles about which the sections of the protective cover adjoining the area 38 extend in opposite directions are identical in the shown embodiment. Depending on the constructive embodiment, a different position of the area 38 can be provided however.

The guiding device 9 is supplied with electric energy by connecting line 12. The connecting line 12 can be guided, for example, about the outer circumference of the protective cover 8 to the housing 2. However, it can also be provided that the energy supply device is arranged directly on the guiding device 9.

FIG. 2 shows the configuration of the drive of the cutting wheel 6. The drive motor 3 has a cylinder 13 in which a combustion chamber 14 is provided. The combustion chamber 14 is delimited by piston 15 that is reciprocatingly supported within the cylinder 13. The piston 15 rotatingly drives a crankshaft 17 about an axis of rotation 27. A spark plug 16 projects into the combustion chamber 14 for igniting the fuel/air mixture in the combustion chamber 14.

On the crankshafts 17 a generator 18 is arranged in which voltage is induced as a result of the rotational movement of the crankshaft 17. The generator 18 is connected to a control unit 26 and supplies it with energy. The guiding device 9 is connected, as shown in FIG. 1, by connecting line 12 to the control unit 26 so that the guiding device 9 is supplied by means of the control unit 26 with electric energy from the generator 18. The control unit 26 can be connected additionally to a switch by means of which the guiding device 9 can be switched on and off. However, it can also be provided that the generator 18 is connected directly to the guiding device 9. Means for switching on and off the guiding device 9 can also be arranged directly on the guiding device 9. The spark plug 16 is also connected to the control unit 26 and is supplied with electric energy from generator 18 via the control unit 26. Adjacent to the generator 18 a fan wheel 19 is arranged on the crankshaft 17 that conveys cooling air for the drive motor 3.

On the opposite side of the drive motor 3 a clutch 20 is arranged on the crankshaft 17. The clutch 20 connects the crankshaft 17 with a pulley 21. On the side of the pulley 21 facing away from the clutch 20 a starter device 23 is provided that serves for starting the drive motor 3. The starting device 23 can be actuated by a starter handle 24.

A drive belt 22 is guided on the pulley 21 and is driven in rotation by the crankshaft 17 by means of clutch 20. As shown in FIG. 3, an extension arm 25 is secured on the housing 2 of the cut-off machine 1 and the drive belt 22 is guided therein. On the end of the extension arm 25 facing away from the housing 2 a drive shaft 28 projects from the extension arm 25 and the cutting wheel 6 is secured on the drive shaft. The drive shaft 28 is rotatingly driven by means of the drive belt 22 about axis of rotation 7 of the cutting wheel 6.

In FIG. 3 the vibration of the protective cover 8 in the plane perpendicular to the cutting wheel 6 is illustrated. This plane is positioned in the usual working position of the cut-off machine 1, illustrated in FIG. 1, approximately horizontally. As shown in FIG. 3, the protective cover 8 vibrates in the form of a standing wave 34. In this connection, the deflection of the protective cover 8 is greatest in the areas of the protective cover 8 adjoining the housing 2 or facing away from the housing 2. In a central area, approximately at the level of the axis of rotation 7 of the cutting wheel 6 in the plan view illustrated in FIG. 3, the standing wave 34 exhibits a node 36. In the node 36 the amplitude of the vibration of the protective cover 8 is zero. The guiding device 9 is secured in this area.

FIG. 4 shows the vibration of the protective cover 8 in a direction radial to the axis of rotation 7. A vibration in the form of a standing wave 34 is formed here also. The amplitude is greatest at the terminal areas of the circumference, i.e., in the area neighboring the housing 2 and in the area facing away from the housing 2. In the central area of the circumference of the protective cover 8 a node 37 of the standing wave 35 is formed in which the amplitude is approximately zero. In this area the guiding device 9 is secured. Depending on the constructive configuration, the node 37 can also be generated in another area of the protective cover 8. The guiding device 9 then is to be positioned appropriately.

The schematic illustration in FIG. 4 shows also an embodiment variant of the energy supply of the guiding device 9. In the housing 2 a battery 33 is arranged that is connected by connecting line 12 to the guiding device 9 and that supplies the guiding device 9 with energy. Because of the battery 33, the guiding device 9 can be switched on even when the drive motor 3 is not running. It is also expedient to provide a switch for switching on and off the guiding device 9; the switch can be arranged on the housing 2 or on the guiding device 9 itself.

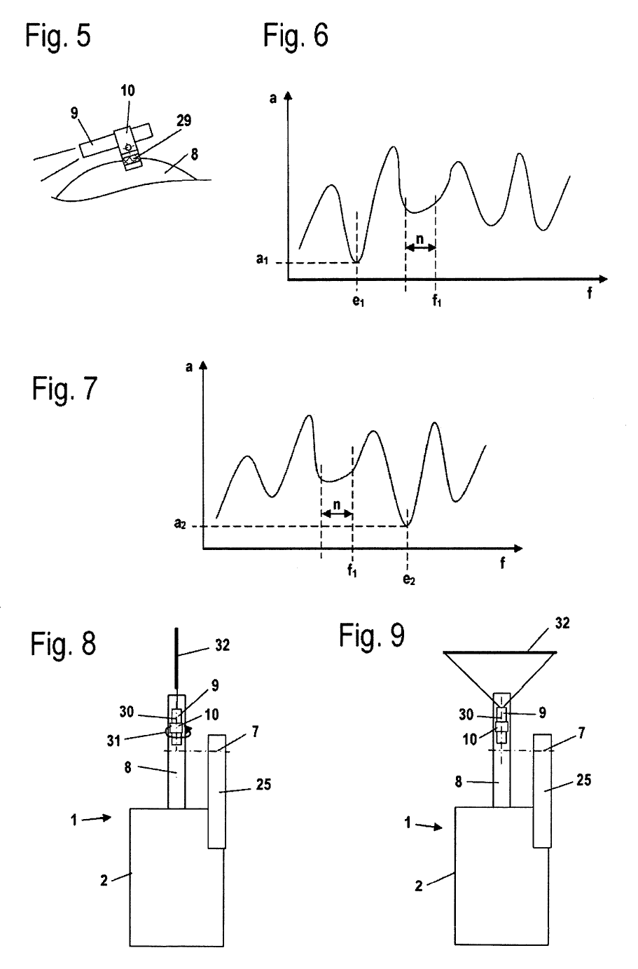

In the embodiment according to FIGS. 1 to 4 the guiding device 9 is arranged in the area of the nodes 36 and 37 of the two standing waves 34 and 35 in order to provide in this way a low-vibration arrangement of the guiding device 9. In addition, or as an alternative, the guiding device 9 can be connected by a vibration damping element 29 with the protective cover 8. This is shown schematically and partially in FIG. 5. Here, a vibration damping element 29 is provided on the holder 10. The vibration damping element 29 can be, for example, a rubber element or a vibration damping element made from foamed plastic material. It can also be advantageous to employ as a vibration damping element a spring element, for example, an element that comprises at least one plate spring or a coil spring. Other vibration damping elements can also be advantageous. It can also be provided that several vibration elements are provided for mounting the guiding device 9.

In order to prevent that the guiding device 9 in operation is excited to perform resonant vibrations, it is provided to adjust the resonant vibration e₁, e₂ of the guiding device 9 to the frequency at which the protective cover 8 vibrates in operation. This is shown in FIGS. 6 and 7.

FIG. 6 shows a first exemplary course to the amplitude a of the protective cover 8 relative to the frequency f at which the protective cover 8 vibrates. The frequency f at which the protective cover 8 vibrates corresponds to the engine speed of the drive motor 3. The frequency f₁ indicates the maximum vibration frequency in operation of the cut-off machine 1. The frequency f₁ corresponds thus to the maximum engine speed. The frequency f₁ limits a working engine speed range n in the upward direction. The working engine speed range n comprises an engine speed band that is below the frequency f₁. The eigenfrequency e₁ is positioned in the embodiment according to FIG. 6 significantly below the frequency f₁. The eigenfrequency e₁ of the guiding device 9 exists at an amplitude a₁ of the protective cover 8 that represents a global and thus also a local minimum of the amplitude a. In this way, the amplitudes with which the guiding device is excited at its eigenfrequency e₁ is comparatively minimal, so that a build-up of the eigenfrequency e₁ of the guiding device 9 is prevented.

In the exemplary course of the amplitude a illustrated in FIG. 7, the guiding device 9 is adjusted to an eigenfrequency e₂ that is significantly above the frequency f₁ of the protective cover 8. In the course of the amplitude a according to FIG. 7, the frequency f₁ refers also to the maximum frequency of the protective cover 8 in operation, i.e., the maximum engine speed of the drive over 3. The amplitude a₂ of the protective cover 8 at the eigenfrequency e₂ is very minimal. The amplitude a₂ represents the global minimum of the amplitude a.

As shown in FIG. 8, the guiding device 9 is rotatably supported about axis of rotation 30 on the holder 10. The axis of rotation 30 is positioned in the longitudinal direction of the guiding device 9 and parallel to the plane of the cutting wheel 6. The axis of rotation 30 is thus positioned in a plane that is perpendicular to the axis of rotation 7. In the illustration of FIG. 8, a rectangular arrangement of the axis of rotation 30 relative to the axis of rotation 7 results. In the rotational position illustrated in FIG. 8 of the guiding device 9 the guiding device 9 generates a guide mark 32 that is embodied as a line parallel to the plane of the cutting wheel 6.

When the guiding device 9 is rotated by 90° in accordance with arrow 31 illustrated in FIG. 8 into the rotational position illustrated in FIG. 9, the guide mark 32 is positioned perpendicularly to the plane of the cutting wheel 6 and parallel to the axis of rotation 7. In this way, by means of the guiding device 9, it is possible to also perform perpendicular cuts. By rotation of the guiding device 9 about other angles, cuts in other angled positions are made possible in a simple way. In order to carry out a rectangular cut, the guide mark 32 illustrated in FIG. 9 can be aligned relative to the edge of a component or, in case of panels to be cut, aligned relative to a transverse groove. The cutting wheel 6 then extends perpendicularly to this groove.

The guiding device 9 can be, for example, a laser that generates a linear guide mark 32. However, other optical guiding devices 9 can be expedient.

The specification incorporates by reference the entire disclosure of German priority document 10 2007 032 043.6 having a filing date of 10 Jul. 2007.

While specific embodiments of the invention have been shown and described in detail to illustrate the inventive principles, it will be understood that the invention may be embodied otherwise without departing from such principles.

What is claimed is:

1. A power tool comprising:
a drive motor that drives a work tool;
an optical guiding device secured on the power tool in alignment relative to the work tool;
wherein the guiding device is arranged in a low-vibration arrangement on the power tool.

2. The power tool according to claim 1, wherein the guiding device is secured on the power tool in a low-vibration area of the power tool.

3. The power tool according to claim 2, wherein, in operation, at least one section of the power tool vibrates in the form of a standing wave in at least one direction, wherein the low-vibration area where the guiding device is arranged is the area of a node of the standing wave.

4. The power tool according to claim 1, further comprising at least one vibration damping element, wherein the guiding device is secured by the at least one vibration damping element on the power tool.

5. The power tool according to claim 1, wherein the eigenfrequency of the guiding device is outside of a working engine speed range of the power tool.

6. The power tool according to claim 1, wherein the eigenfrequency of the guiding device is at a frequency at which an amplitude of the vibration of the power tool has a local minimum.

7. The power tool according to claim 1, wherein the eigenfrequency of the guiding device is at a frequency at which an amplitude of the vibration of the power tool has a global minimum.

8. The power tool according to claim 1, wherein the guiding device produces a line-shaped guide mark.

9. The power tool according to claim 1, wherein the guiding device is rotatably arranged about a first axis of rotation on the power tool.

10. The power tool according to claim 9, wherein the work tool is rotatingly driven about a second axis of rotation, wherein the first axis of rotation of the guiding device is positioned in a plane that is perpendicular to the second axis of rotation of the work tool.

11. The power tool according to claim 1, wherein the guiding device is pivotably arranged on the power tool.

12. The power tool according to claim 11, wherein the work tool is rotatingly driven about an axis of rotation, wherein the guiding device is pivotable about a pivot axis that is parallel to the axis of rotation of the work tool.

13. The power tool according to claim 1, further comprising an energy supply device that supplies the guiding device with electric energy.

14. The power tool according to claim 13, wherein the energy supply device is a generator.

15. The power tool according to claim 14, wherein the drive motor is an internal combustion engine and has a rotatingly driven crankshaft, wherein the generator is arranged on the crankshaft of the drive motor.

16. The power tool according to claim 13, wherein the energy supply device is a battery.

17. The power tool according to claim 1, wherein the power tool is a cut-off machine and the work tool is a rotatingly driven cutting wheel, wherein the cut-off machine comprises a protective cover that covers at least partially the cutting wheel, and wherein the guiding device is arranged on the protective cover.

18. The power tool according to claim 17, wherein the guiding device is arranged on the protective cover so as to be positioned in the same plane as the cutting wheel.

19. The power tool according to claim 17, wherein the guiding device is arranged on the circumference of the protective cover in a central area of the circumference of the protective cover.

20. The power tool according to claim 1, wherein the drive motor is an internal combustion engine.
